(19) United States
(12) Patent Application Publication
(10) Pub. No.: US 2024/0215142 A1
(43) Pub. Date: Jun. 27, 2024

(54) DIELECTRIC BARRIER DISCHARGE PLASMA ACTUATORS

(71) Applicant: UNIVERSITY OF WASHINGTON, Seattle, WA (US)

(72) Inventors: Ravi Sankar Vaddi, Seattle, WA (US); Igor V. Novosselov, Seattle, WA (US); Alexander V. Mamishev, Seattle, WA (US)

(73) Assignee: UNIVERSITY OF WASHINGTON, Seattle, WA (US)

(21) Appl. No.: 18/553,839

(22) PCT Filed: Jun. 2, 2022
(86) PCT No.: PCT/US2022/031900

§ 371 Date: Dec. 8, 2023

Related U.S. Application Data
(60) Provisional application No. 63/196,098, filed on Jun. 2, 2021.

(51) Int. Cl. H05H 1/24; B64C 23/00; F15D 1/00; F15D 1/12

(52) U.S. Cl. CPC H05H 1/2439; B64C 23/005; F15D 1/0075; F15D 1/12

(57) ABSTRACT

Dielectric barrier discharge plasma actuators are described. In one embodiment, a fluid flow actuator includes: a dielectric sheet; and a first electrode of a dielectric barrier discharge-direct current augmented (DBD-DCA) actuator disposed on a first face of the dielectric sheet. The first electrode is exposed to a surrounding fluid. The fluid actuator also includes a second electrode of the DBD-DCA actuator disposed on a second face of the dielectric sheet. The second face of the dielectric sheet is opposite from the first face of the dielectric sheet. The first electrode and the second electrode are configured for receiving an alternating current (AC) voltage configured to locally ionize the fluid and to generate ions. A third electrode located downstream from the first electrode and the second electrode. The third electrode is configured for receiving a direct current (DC) voltage configured to accelerate the ions.

### CROSS-REFERENCE TO RELATED APPLICATION

This application claims the benefit of U.S. Patent Application No. 63/196,098, filed Jun. 2, 2021, the disclosure of which is hereby incorporated by reference in its entirety.

### STATEMENT OF GOVERNMENT LICENSE RIGHTS

This invention was made with government support under Grant No. 2017-17073100004, awarded by the Office of the Director of National Intelligence (ODNI), IARPA. The government has certain rights in the invention.

### BACKGROUND

Flying trajectory of traditional aircraft is controlled using the actuated control surfaces like ailerons, rudders and flaps. These actuators control the roll, pitch and yaw of the aircraft. More recently, flow around aircraft and other airfoil structures (e.g., turbine vanes, submarine surfaces, etc.) is controlled by active flow control systems, for example, suction devices, miniature pumps (micro-electro-mechanical system (MEMS) or piezoelectric pumps) or synthetic jets. However, such control mechanisms are still generally bulky, energy inefficient, and may have significant mechanical delays.

Dielectric barrier discharge (DBD) plasma actuators are an attractive option for controlling fluid flow separation, lift enhancement and drag reduction because of their light weight, fast response time and energy efficiency. Some plasma actuator designs optimize the electrode shapes and electrical waveforms to maximize the aerodynamics forces at high angles of attack.

With some conventional technologies, a DBD actuator includes two copper electrodes, one exposed to airflow and one encapsulated, that are separated by a dielectric material, as discussed with respect to FIG. 3 below. The electrodes may have straight edges that produce a uniform spanwise discharge. The plasma actuator is installed on an airfoil structure (e.g., an aircraft wing). The exposed electrode may be glued onto the top of the Kapton dielectric layer. The ground electrode (encapsulated electrode) may be flush-mounted on the upper or lower side of the airfoil structure. The encapsulation prevents plasma formation on the lower side of the dielectric material.

In operation, plasma is generated by applying an alternate current (AC) to the electrodes of the actuator. Next, plasma is swept downstream of the sensor by the fluid flow. The presence of plasma may improve the aerodynamics of the flow around the airfoil. For example, plasma may cause delayed flow separation along the airfoil. However, in many applications, conventional plasma actuators may not be sufficiently effective in achieving the desired effects on the fluid flow. Accordingly, systems and methods are required for improved control of the fluid flow using the plasma actuators.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Briefly, a plasma actuator that includes three electrodes is configured for controlling the flow around an object. The plasma actuator includes two electrodes of a dielectric barrier discharge (DBD) actuator and a DC electrode downstream of the DBD. Such a three-electrode actuator may be referred to as a dielectric barrier discharge-direct current augmented (DBD-DCA) actuator. Without being bound to theory, it is believed that the third electrode of the DBD-DCA actuator accelerates the flow of ions generated by the first and second electrodes that are located upstream of the third electrode, therefore slowing the growth of the boundary layer along the airfoil, in turn delaying the formation of a recirculation zone and separation of the boundary layer. As a result, a lift coefficient may be increased while a drag coefficient is reduced. In some embodiments, an opposite effect, that is, promoting an earlier separation of the boundary layer can be achieved by manipulating the polarity of the third electrode. Other outcomes, for example, related to improved flight control of aircraft, are also possible in different embodiments.

Thrust force associated with the induced wall jet can be varied over a range of input parameters, e.g., AC voltage, frequency, and DC voltage. In different embodiments, the DC voltage of the third electrode may be positive or negative.

Different electrode shapes may be used to improve the performance of the DBD-DCA actuator. For example, the first electrode may be shaped as a saw-tooth shape, finger shape, or as a parallel array of the conductive material separated by the dielectric. In some embodiments, the DBD-DCA plasma actuator is installed on a NACA 0012 airfoil in a co-flow configuration to improve fluid flow, therefore improving the lift coefficient, drag coefficient, and pitching moment coefficients of the airfoil.

In some embodiments, the third electrode (the DC electrode) potential significantly increases the lift coefficient, up to 25%, and decreases the drag by 60% for a range of flow speeds. Generally, significant control forces may be obtained using DBD-DCA plasma actuator, and these control forces can be used to generate moments for aircraft maneuvering.

In some embodiments, the DBD-DCA plasma actuator can be installed in a counterflow configuration, thus retarding lift and drag but providing significant control of the pitching moment.

In one embodiment, a fluid flow actuator includes a dielectric sheet and a first electrode of a dielectric barrier discharge-direct current augmented (DBD-DCA) actuator. The first electrode is disposed on a first face of the dielectric sheet, where the first electrode is exposed to a surrounding fluid. A second electrode of the DBD-DCA actuator is disposed on a second face of the dielectric sheet, where the second face of the dielectric sheet is opposite from the first face of the dielectric sheet. The first electrode and the second electrode are configured for being coupled an alternating current (AC) voltage source that is configured to locally ionize the surrounding fluid and to generate ions. A third electrode of the DBDA-DCA actuator is disposed downstream from the first electrode and the second electrode, where the third electrode is configured for being coupled to a direct current (DC) voltage source configured to accelerate the ions.

In one aspect, the third electrode is exposed to the surrounding fluid.

In one aspect, the first electrode is saw-tooth shaped in a spanwise direction.

In another aspect, the first electrode is finger-design shaped in a spanwise direction.

In one aspect, the third electrode is energized to a negative DC voltage.

In one embodiment, the fluid flow actuator also includes a source of the AC voltage coupled to the first electrode and the second electrode.

In one embodiment, the fluid flow actuator also includes a source of the DC voltage coupled to the third electrode.

In one embodiment, the fluid flow actuator is mounted on a surface of an aerodynamic structure.

In one aspect, a thrust generated by the actuator corresponds to:

$$T = ( 1 - θ ) {F}_{EHD}$$

where F_{EHD} is a force induced by the ions corresponding to:

$${F}_{EHD} = {K}_{1} {{f}_{AC}^{α} ( {φ}_{AC} - {φ}_{o} )}^{2}$$

where K₁ and α are experimental constants corresponding to K₁=22.4×10⁻⁶ and α=0.8, φₒ is an initiation voltage, f_{AC} is a frequency of the AC voltage source, φ_{AC} is a voltage of the AC source, and θ is a non-dimensionless experimental quantity.

In one embodiment, a method of accelerating fluid over an aerodynamic structure includes exposing a dielectric barrier discharge-direct current augmented (DBD-DCA) actuator to a flow of fluid. The DBD-DCA actuator includes a first electrode disposed on a first face of a dielectric sheet and exposed to a surrounding fluid, and a second electrode disposed on a second face of the dielectric sheet opposite from the first face. The method also includes energizing the first electrode and the second electrode by an alternating current (AC) voltage; locally ionizing the fluid to generate ions in the fluid; and accelerating the ions using a third electrode of the DBD-DCA actuator that is coupled to a direct current (DC) voltage. The third electrode is configured downstream of the first electrode and the second electrode, where the third electrode acts as an electrical sink that attracts the ions.

In one aspect, the third electrode is energized to a negative DC voltage.

In another aspect, the third electrode is energized to a positive DC voltage.

In one aspect, the third electrode is exposed to the surrounding fluid.

In one aspect, the third electrode is covered by an electrically insulating sheet.

In one aspect, the first electrode is saw-tooth shaped in a spanwise direction.

In another aspect, a distance between adjacent saw-teeth of the first electrode is about the same as a height of the saw-teeth.

In another aspect, the first electrode is finger-design shaped in a spanwise direction.

In another aspect, a distance between adjacent fingers of the first electrode is about twice smaller than a height of the fingers.

In one aspect, the first electrode is finger-design shaped in a spanwise direction.

In one aspect, the actuator is mounted on a surface of an aerodynamic structure.

In one aspect, the actuator is configured on a surface of an aerodynamic structure in a co-flow orientation.

In another aspect, the actuator is configured on a surface of an aerodynamic structure in a counter-flow orientation.

In one aspect, the actuator is configured on a surface of an aerodynamic structure at an arbitrary angle to the free stream.

In one aspect, the aerodynamic structure is configured on a lifting surface of an aircraft.

In another aspect, the actuator is configured on a non-lifting surface of the aircraft.

In one aspect, the actuator is configured on a suction side of an airfoil.

In another aspect, the actuator is configured on a pressure side of an airfoil.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 illustrates an aircraft in accordance with conventional technology;

FIG. 2 illustrates generating ionic wind in accordance with conventional technology;

FIG. 3 illustrates a dielectric barrier discharge (DBD) plasma actuator in accordance with conventional technology;

FIG. 4 illustrates a dielectric barrier discharge-direct current augmented (DBD-DCA) plasma actuator in accordance with embodiments of the present technology;

FIGS. 5A and 5B are schematic diagrams of a plasma actuator in operation according to embodiments of the present technology;

FIG. 6 illustrates a DBD-DCA plasma actuator placed over a NACA foil in accordance with embodiments of the present technology;

FIGS. 7A and 7B illustrate a plasma actuator in operation according to embodiments of the present technology;

FIGS. 8A-8D illustrate different electrode shapes according to embodiments of present technology;

FIG. 9 is a graph of measured thrust using a DBD-DCA plasma actuator according to embodiments of the present technology; and

FIG. 10 is a graph of measured thrust using a DBD-DCA plasma actuator according to embodiments of the present technology.

### DETAILED DESCRIPTION

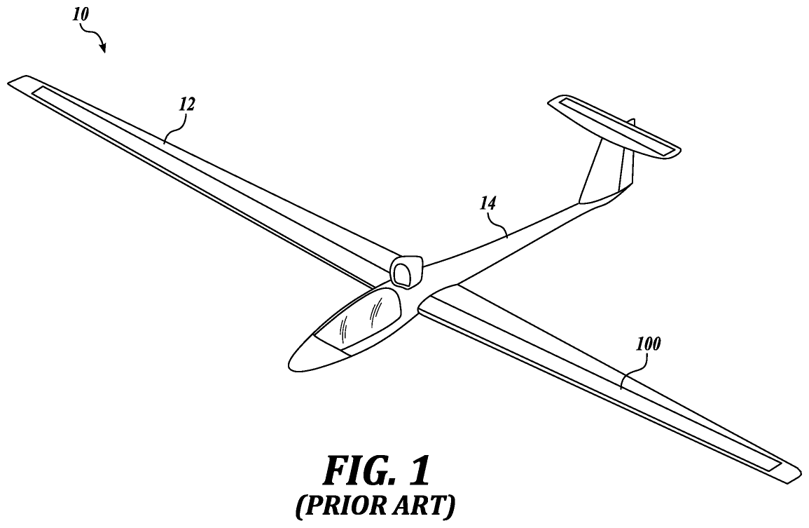

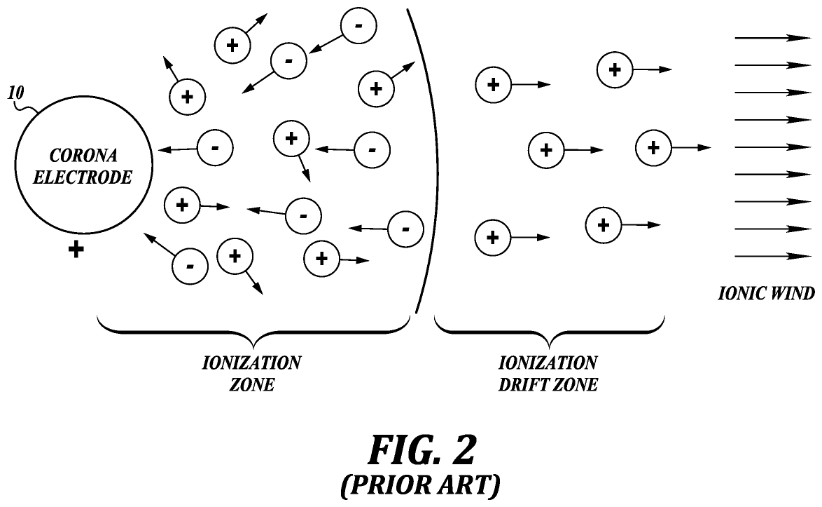

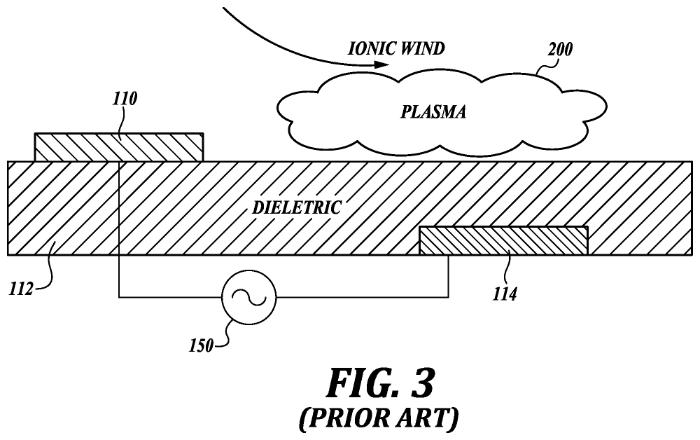

FIG. 1 illustrates an aircraft 10 in accordance with conventional technology. The illustrated aircraft includes fixed wings 12 and a body 14, which may be composite. Actuators 100 are configured spanwise on the wings 12. In operation, the actuators 100 can manipulate the flow of air to, for example, increase lift coefficient, reduce drag coefficient, and/or control pitching moment coefficients of the wing airfoil. Such effects may be achievable by manipulating flow structure using suction devices, miniature pumps, sources of miniature jets, etc. In practical terms, the operation of the actuator 100 may delay the onset and growth of the boundary layer, thus improving the aerodynamics of the aircraft 10. Some conventional actuators are based on the electrohydrodynamic (EHD) actuators, as explained in more detail with respect to FIGS. 2 and 3 below.

FIG. 2 illustrates generating the ion wind in accordance with conventional technology. The illustrated EHD actuator has an electrode 10 that is subjected to an AC voltage. When a sufficient electrical potential is applied to the electrode 10, the electrical breakdown of air occurs. The region in the vicinity of the electrode 10 is known as the ionization region, where positive and negative ions are generated. The illustrated actuator may include another (ground) electrode or may rely on the objects in the vicinity as the electrical ground.

The ionization of the air takes place within the ionization zone. As the polarity of the electrode 10 changes, ions will be attracted-to or repulsed-from the electrode 10 during different parts of the AC cycle. However, over many AC cycles, the positive ions tend to be attracted less to and repulsed more from the electrode 10, resulting in a flow of the positive ions away from the electrode 10 within the ionization drift zone. As the positive ions leave the ionization drift zone, the attractive force of the electrode 10 becomes even weaker, and the positive ions form an ion wind.

FIG. 3 illustrates a dielectric barrier discharge (DBD) plasma actuator in accordance with conventional technology. An AC source 150 is connected between a first electrode 110 and a second electrode 114. The first and second electrodes are separated by a dielectric 112. As explained above, the operation of the AC source generates an ion wind, which is swept downstream of the ion-generating first electrode 110 as a plasma 200. Here, the plasma 200 is accelerating the bulk flow by collision with the neutral molecules in the ionization drift region.

The above-described electrohydrodynamic (EHD) flow generated by the DBD actuator may be understood as the motion of electrically charged fluids under the influence of applied electric fields. The DBD actuators operate at a small scale without moving parts, thus enabling a straightforward control of the system and quiet operation. For example, in propulsion applications, the DBD actuators convert electrical energy directly to kinetic energy, therefore sidestepping limitations related to the design and manufacturing of small moving parts as in other conventional flow actuators. However, the applicability of the DBD actuators is limited due to the modest pressure that they generate.

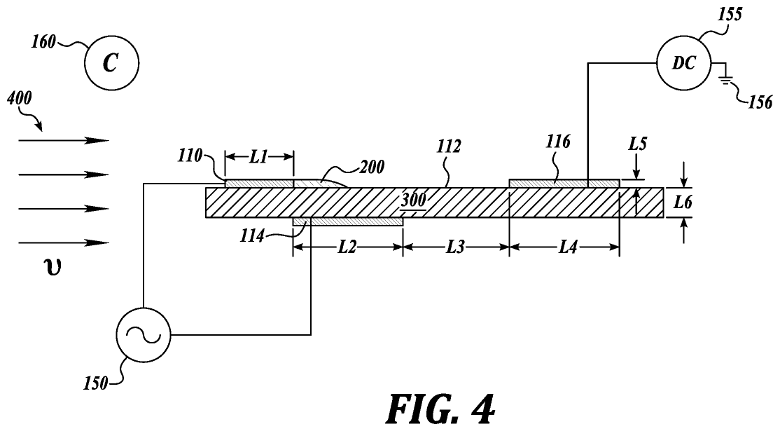

FIG. 4 illustrates a dielectric barrier discharge-direct current augmented (DBD-DCA) plasma actuator in accordance with embodiments of the present technology. In some embodiments, the first electrode 110 and the second electrode 114 are 0.05 mm thick copper electrodes. The first electrode 110 is exposed to the incoming air flow U, and is separated from the encapsulated electrode 114 by a dielectric material 112. Operation of the AC source 150 that is electrically coupled between the first electrode 110 and the second electrode 114 generates plasma 200.

In some embodiments, a third electrode 116 is positioned further downstream from the first electrode 110 and second electrode 114. The third electrode 116 may be exposed to a flow of air/ions. In different embodiments, the third electrode 116 may be connected to a DC source 155 or may be grounded. In operation, the third electrode acts as a sink for the ions traveling in the ionic wind, therefore accelerating the ionic wind and generating additional kinetic energy and pressure differential over a surface of the aerospace structure.

The electrodes 110, 114, 116 may be made of suitable electrical conductors, for example, copper, aluminum, carbon, etc. The illustrated aerospace structure 300 is a 0.15 m (L6) by 0.2 m flat polylactic acid polymer (PLA) plate. The electrodes 110, 114, 116 extend in a spanwise direction (i.e., into the plane of paper). In some embodiments, the electrodes include straight edges suitable for producing a uniform spanwise discharge.

In some embodiments, the dielectric 112 includes four layers of Kapton-HN and one layer of Kapton-CRC (corona resistant) with a total thickness of ˜300 μm (including the adhesive). The exposed first electrode 110, having a length L1 is attached to the top of the Kapton dielectric layer. The second electrode having a L2 may be flush-mounted on the bottom side of the aerospace structure 300. The second electrode may be encapsulated to prevent plasma formation on the lower side of the dielectric material of the aerospace structure 300. In the illustrated embodiments, there is no vertical overlap between the first electrode 110 and the second electrode 114, i.e., there is no overlap between L1 and L2. The length of the third electrode 116 is L4, and the third electrode is further offset from the edge of the second electrode 114 by a distance L3. The electrodes may have the same thickness L6 or different thicknesses.

Some non-limiting values for the above-discussed dimensions are L1=15 mm, L2=25 mm, L3=25 mm, L4=25 mm, and L6=0.3 mm. In some embodiments, the first electrode 110 may be positioned at 10 mm from the leading edge of the flat plate. A representative, non-limiting span of the aerospace structure 300 is about 100 mm. However, in different embodiments, different values of the above dimensions are possible.

A non-limiting example of the AC source 150 is a Trek PM0414 power supply that provides up to 20 kV AC high voltage. A non-limiting example of the DC source 155 is an HV DC power supply (Bertan 205B-20R) with variable DC voltage (0-18 kV). In different embodiments, the DC source may provide a negative or a positive voltage, depending on whether it is desirable to accelerate the ion wind or to slow it. The DC power supply may terminate in a ground 156. In some embodiments, the operation of the AC source 150 and DC source 155 may be controlled by a controller 160.

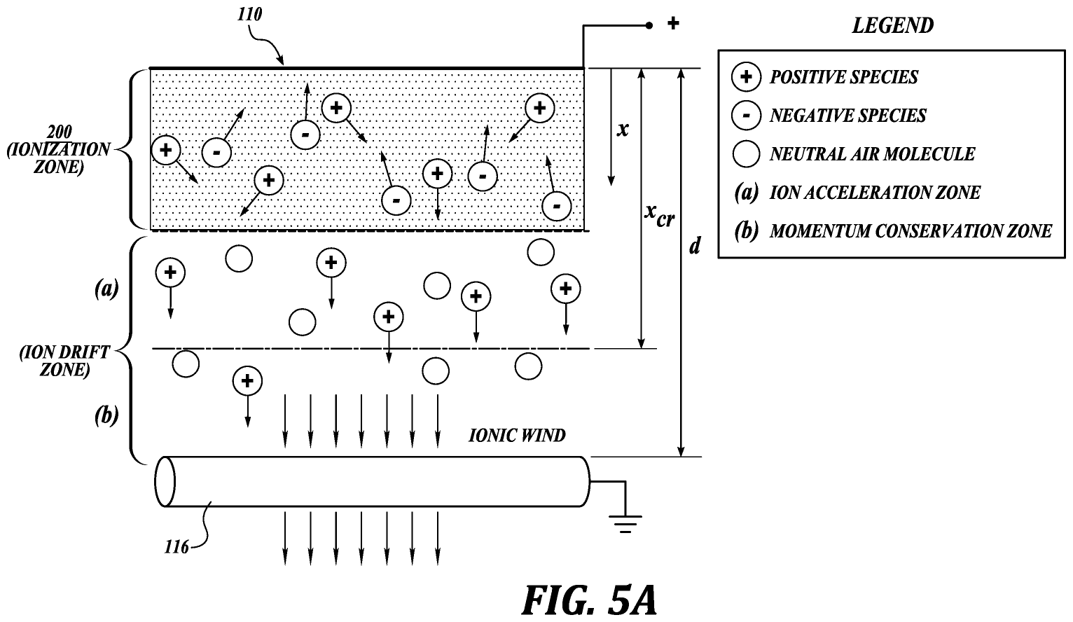

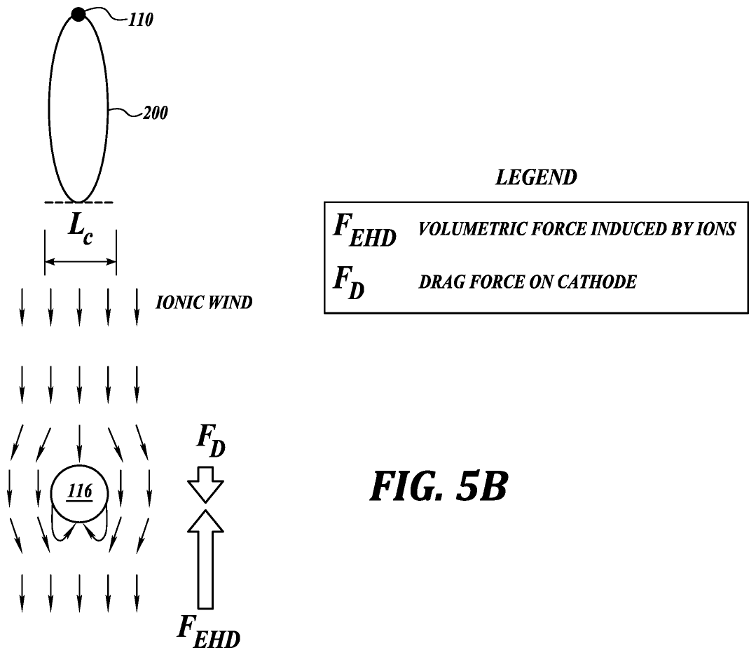

FIGS. 5A and 5B are schematic diagrams of a plasma actuator in operation according to embodiments of the present technology. These schematic diagrams illustrate a wire-to-cylinder EHD flow. In positive corona, the negative species produced in the ionization zone recombine with positive species or at the emitter electrode (electrode 110). The super-equilibrium positive ions drift to the collector electrode (electrode 116), accelerating the bulk flow. Thrust force is the resultant of the Coulombic force induced by the ions and drag force on the cathode. The above conceptual representation of the EHD system includes ionization zone 200, ion acceleration region (a) where unipolar ion motion in the gas medium acts as a body force accelerating the flow, and momentum conservation region (b) where the electric force is balanced or overcome by viscous effects.

In some embodiments, the thrust of the induced jet by the plasma actuator can be measured as a reaction force by, for example, suspending the electrodes 110 and 116 on a weight balance. The thrust itself can be measured as a reduction in weight measured by the weight balance (scale). The experimental procedure may be as follows: (i) the high voltage is switched off, and the mass of the plate is recorded, (ii) the high voltage is switched on and the difference in the mass measurements is determined, (iii) the experiment is repeated for the range of voltages and frequencies values at increments of, for example, 1 kV and 1 kHz respectively. The measurement difference between steps (i) and (ii) corresponds to the thrust force generated by the plasma actuation.

In some embodiments, the experiments are performed in a room with a temperature range of 22° C.-25° C., a relative humidity of 24%-26%, and ambient pressure. The frequency on the AC power supply may be varied from 1 kHz-2 kHz and for each frequency, the peak-to-peak voltage φ(t) is increased from 12 kV (when the thrust force becomes measurable reliably) to 19 kV (power supply limit). For each input voltage, several measurements may be recorded from the scale over, for example, a 60-second span once an initial stable reading was reached. The maximum error associated with the measurement is typically within 5%.

The thrust force data can be used to determine the momentum injection associated with the DBD wall jet. FIG. 1.3 shows the thrust data for the range of φ_{AC}=12 kV-19 kV and f_{AC}=0.5 kHz-2 kHz. The thrust increases with φ and f_{AC}, and follows a trend that is proportional to f_{AC}^{α}φ_{AC}² as shown in Eq. (1):

$${F}_{EHD} = {K}_{1} {{f}_{AC}^{α} ( {φ}_{AC} - {φ}_{o} )}^{2} \qquad ( 1 )$$

where F_{EHD} is the force due to force induced by the ions, K₁=22.4×10⁻⁶ and α=0.8 are experimental constants and φₒ is the initiation voltage. At φ_{AC}=18 kV and f_{AC}=2 kHz, the thrust was measured at 12.46 mN/m. A momentum injection of 17.3 mN/m may be based on the velocity measurements at X=15 mm from the exposed electrode (plate length ˜40 mm). The measured thrust in this experiment (plate length=200 mm) is the result of the momentum injection driven by EHD and viscous losses, so Eq. (1) can be modified to account for viscous shear as shown in Eq. (2):

$$T = ( 1 - θ ) {F}_{EHD} \qquad ( 2 )$$

Here θ is a non-dimensionless quantity that accounts for the shear forces. The value of θ has to be less than unity and is dependent on plate length and other factors such as electrode arrangement, plate roughness etc. The experimental data can be used to determine θ in Eq. (2). Here, θ=0.2 has the best correlation suggesting that for given parameters the viscous drag on the 200 mm plate from the DBD wall jet is ˜20%.

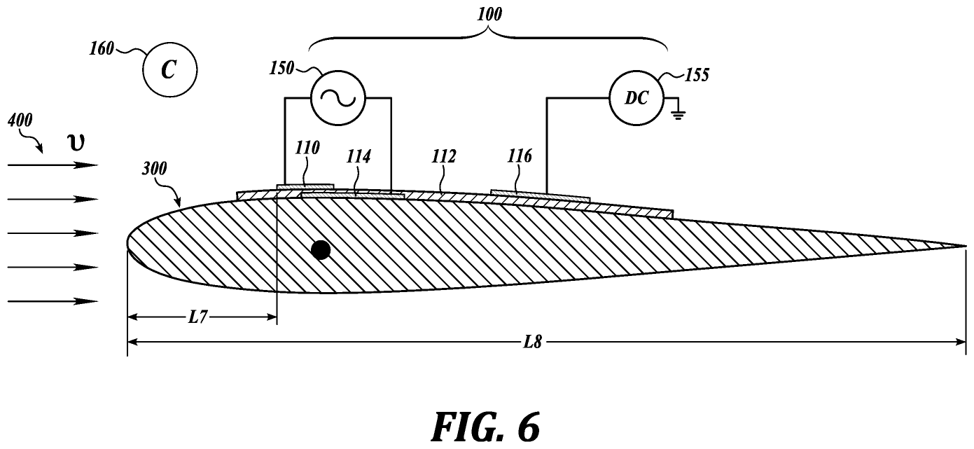

FIG. 6 illustrates a DBD-DCA plasma actuator 100 placed over a NACA airfoil (aerodynamic structure) in accordance with embodiments of the present technology. In some embodiments, the airfoil is a NACA 0012 airfoil, but other airfoils or aircraft structures are also possible in different embodiments. For example, the illustrated airfoil is known in the art as a lifting structure, having a lifting surface. In other embodiments, the DBD-DCA plasma actuator 100 may be placed over a non-lifting surface (e.g., a fuselage of an aircraft). In the illustrated embodiment, the actuator 100 is placed on a suction side of the airfoil (the upper side), however, in different embodiments the actuator 100 may be placed on a pressure side of the airfoil (the lower side). In the illustrated embodiment, the airfoil operates at a low angle of attach with respect to the incoming flow (free stream). However, in general the aerodynamic structure may operate at an arbitrary angle with respect to the incoming free stream.

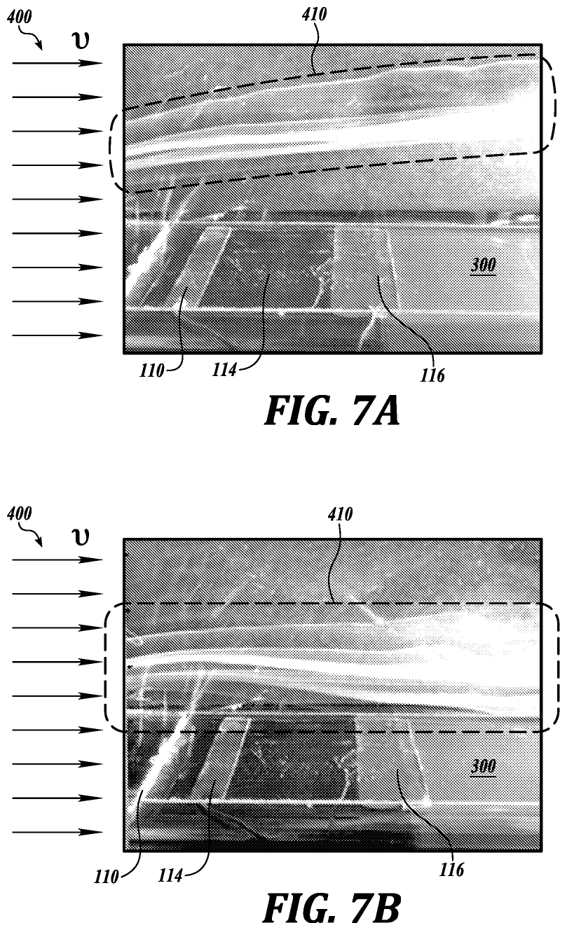

In the illustrated embodiment, the first electrode 110 is exposed, and the second electrode 114 is encapsulated. The first electrode and the second electrode overlap. The width of the second electrode is 25 mm, which is long enough to allow for the development of the plasma sheet. The third electrode 116 has a width of 25 mm, and can be placed 20 mm from the downstream edge of the second electrode. The spanwise length of the electrodes is 350 mm. The actuator is installed at a distance L7, which is 18% chord from the leading edge (x/c=0.18 or L7/L8=0.18). The location is selected based on the expected position of a separation bubble for NACA 0012 airfoil: 0.1 c-0.6 c for α=2°-8° at Re=3×10⁵. A person of ordinary skill would understand that the above-quoted values are for illustration only, and other values are also possible in different embodiments. In the illustrated embodiment, the operation of the actuator 100 may serve to delay the separation bubble further downstream along the airfoil 300 (also referred to a co-flow orientation). In different embodiments, the operation of the actuator 100 may serve to move the separation bubble upstream, thus promoting the growth of the boundary layer and the separated shear layer (also referred to as a counter flow orientation). Some examples of such delay in boundary layer separation are explained with respect to FIGS. 7A and 7B below.

FIGS. 7A and 7B illustrate a plasma actuator in operation according to embodiments of the present technology. In particular, the DBD-DCA plasma actuator is configured on an aerospace structure 300, which is placed in a wind tunnel. The fluid flow over the aerospace structure is visualized using, for example, a smoke wire to. The visualization highlights flow differences between two cases: FIG. 7A where the third electrode 116 is de-energized, and FIG. 7B where the third electrode 116 is energized to a pre-determined DC voltage. In both cases, the aerodynamic properties of the aerospace structure 300 may be characterized by the behavior of the fluid structure (e.g., a boundary layer) 410. When the third electrode 116 is de-energized (FIG. 7A), the DBD-DCA plasma actuator exhibits smaller entrainment of the ion flow toward the third electrode 116, therefore producing a smaller thrust T. As a result, the flow structure 410 develops faster and separates earlier from the aerospace structure 300. On the other hand, FIG. 7B illustrates a case where the third electrode 116 is energized to a predetermined value of DC voltage, for example, a negative DC voltage that attracts the flow of the positive ions. In this case, the entrainment of the ion flow increases, therefore resulting in a larger thrust T. As a result, the flow structure 410 is pulled toward the surface of aerospace structure 300, therefore, the flow structure 410 grows slower and separates from the aerospace structure 300 further downstream. In many applications, such delayed separation of the flow structure 410 from the surface of the aerospace structure 300 beneficially increases a lift coefficient (C_{L}) and decreases the drag coefficient (C_{D}) of the aerospace structure.

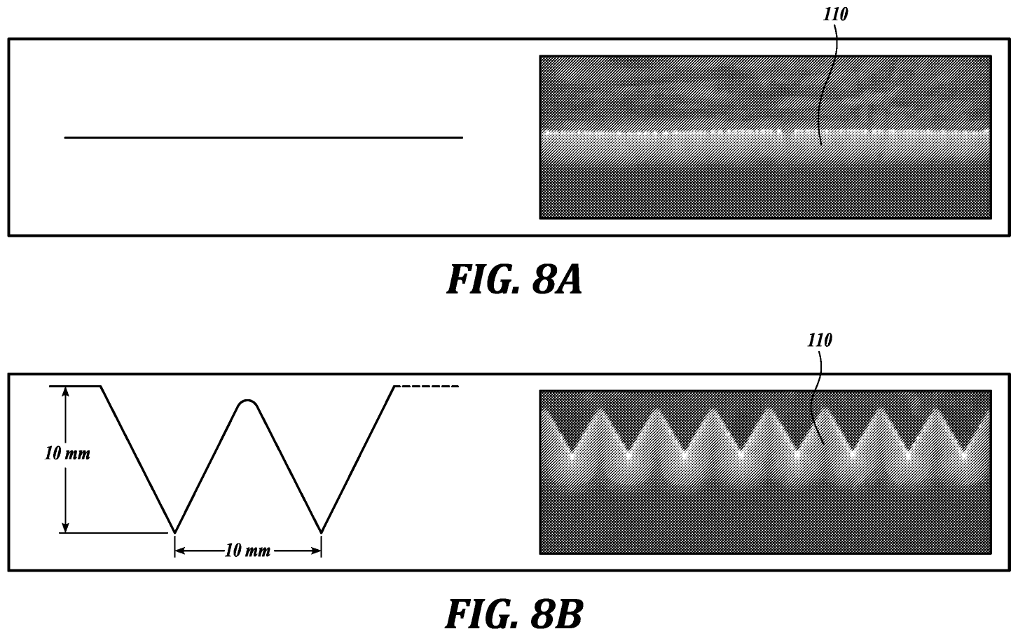

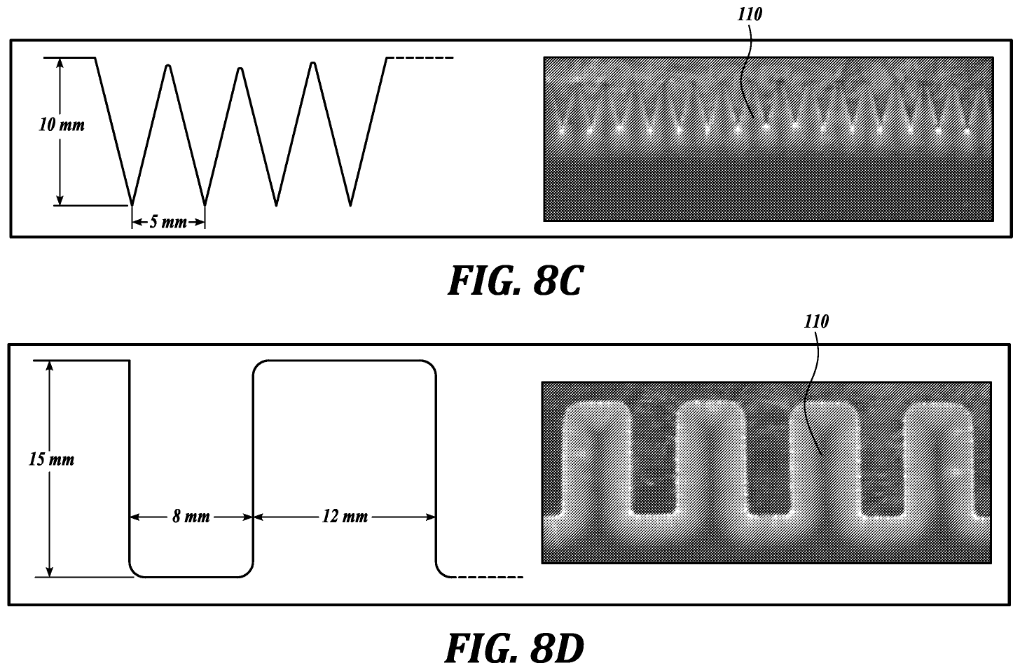

FIGS. 8A-8D illustrate different electrode shapes according to embodiments of the present technology. Bright spots distributed over the outline of the shapes indicate plasma being generated. In particular, FIG. 8A illustrates a linear design for the first electrode 110, FIG. 8B illustrates a saw-tooth coarse design, FIG. 8C illustrates a saw-tooth fine design, and FIG. 8D illustrates a finger design. The geometric parameters of sample plasma actuators are shown in Table 1 below. However, different values of geometric parameters are possible in different embodiments.

TABLE 1
Summary of geometric parameters of sample plasma actuators

| | | | Plasma |
|---|---|---|---|
| Electrode shape | L₁ (mm) | L₂ (mm) | Length (mm) |
| Linear | 15 | 0 | 100 |
| Sawtooth - Coarse | 15 | 10 | 220 |
| Sawtooth - Fine | 15 | 10 | 412 |
| Fingers | 20 | 15 | 238 |

The thrust of the DBD-DCA actuator can be measured for an energized or a non-energized (grounded) third electrode 116. In some embodiments, the thrust forces of DBD-DCA actuator with saw-tooth and fingers electrode (FIGS. 8B-8D) enhances the momentum injection. The coarse saw-tooth electrode (FIG. 8B) generates maximum thrust; at the maximum voltages tested, a thrust of 27.5 mN/m and 42.8 mNm was measured for the AC source at 1 kHz and 2 kHz, respectively. This corresponds to a 2.5× increase over linear electrode DBD-DCA and 2.9× increase over the conventional two-electrode DBD (even when the third electrode 116 is grounded, the improvements are expected to be more significant when the third electrode 116 is energized to a DC voltage). The increase in thrust can be explained by two mechanisms:
1. Momentum injection: Increase in induced jet velocity due to greater plasma volume and plasma intensity at the saw-tooth tips; and
2. Vorticity generation: As the momentum in DBD is injected perpendicular to electrode's edge, the contoured electrode creates vortex structures as the oblique (or opposing in case of the fingers electrode) wall jets collide.

The vortices propagate downstream, entraining into the boundary layer, thus increasing the thrust force. The thrust of the fine saw-tooth actuator decreases by 20% (but is still 2× that of the linear electrode DBD-DCA) compared to a coarser saw-tooth design. Without being bound to theory, it is believed that this is due to a narrow jet and less efficient vortex structure generated by the fine saw-tooth design. With the finger electrodes, the thrust improvement is only 2.3× over the linear electrode and is 10% lower than for the coarse saw-tooth electrode at the same operating conditions. This is likely due to a significant amount of power being used to create transverse (spanwise) opposing wall jets, whereas the saw-tooth electrode induces oblique wall jets that are efficient at injecting streamwise momentum and generating large vortex structures.

In many cases, the thrust generated at the same AC voltage of the first electrode 110 by different designs of the first electrode increase in the following progression: linear case (FIG. 8A), saw-tooth fine (FIG. 8C), fingers (FIG. 8D), saw-tooth coarse (FIG. 8B).

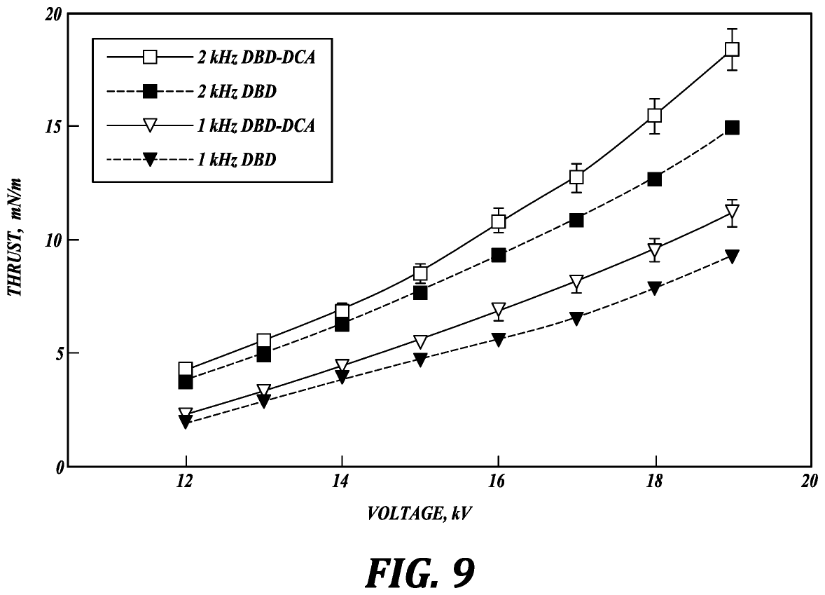

FIG. 9 is a graph of measured thrust using a DBD-DCA plasma actuator according to embodiments of the present technology. The thrust of the DBD-DCA actuator with a non-energized DC electrode (grounded) is compared with the two-electrode DBD actuator. The measured thrust results indicate a minimum improvement of 10% at low AC voltages with the addition of a third electrode. This increase is observed for both frequencies (1 kHz and 1 kHz). At the maximum voltages tested, a difference of 1.96 mN/m and 3.45 mN/m was measured between DBD and DBD-DCA for 1 kHz and 2 kHz, respectively. This corresponds to about 20% increase in thrust for the DBD-DCA actuator. The mechanism may be based on two complementary effects:
i. Surface charge redistribution: The third electrode acts as a sink for the charges accumulated on the dielectric surface during each half-cycle reducing the parasitic effect of ions traveling upstream in the other half cycle.
ii. Ion acceleration due to electrical field modification: Adding a ground downstream of the ionization region modifies instantaneous electrical field shape, accelerating flow in the X-direction more efficiently. This effect is significantly enhanced in the energized DBD-DCA discharge.

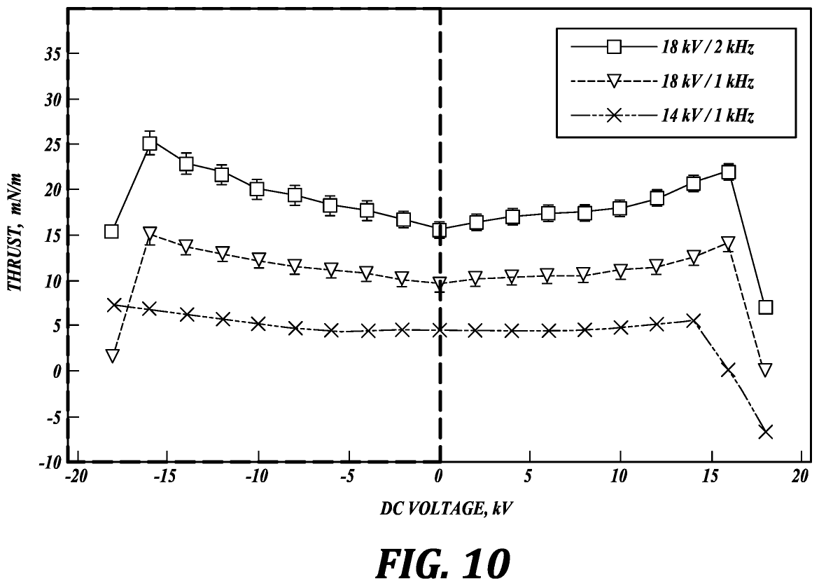

FIG. 10 is a graph of measured thrust using a DBD-DCA plasma actuator according to embodiments of the present technology. FIG. 10 illustrates that additional improvements in thrust can be obtained by accelerating the ions in the increasing E-field. The graph shows that the thrust generated by the DBD-DCA depends on the applied DC voltage. Positive and negative DCA regimes can be identified. Similar to the grounded DBD-DCA discharge, the thrust increase can be attributed to several effects; however, the primary mechanism is believed to stem from the greater acceleration of the opposite charge species during the corresponding half-cycle. For example, species produced in the negative half cycle are more efficiently accelerated in the positive DCA configuration leading to an overall increase in thrust and vice versa.

For positive DCA (i.e., φ_{DC}>0, positive DC voltage applied to the third electrode), the thrust increases with the potential and reaches a maximum at φ_{DC}=14˜16 kV and drops to near zero or reverses direction in some cases. At φ_{AC}=18 kV and f_{AC}=2 kHz, the thrust reached ˜22 mN/m at φ_{DC}=16 kV, which is 1.73× higher than standard two-electrode DBD at the same conditions. In this case, only the transport of the negative discharge is enhanced in the X-direction because of the electric field created between the exposed, the ground, and the positive DCA electrode. The thrust gained in the negative half-cycle is higher than the reduction in the positive half-cycle, resulting in an overall higher thrust. As the DC voltage increases further, the thrust is reversed. This is likely due to the onset of positive discharge on the DCA electrode and subsequent generation of the EHD jet in the “−X” direction.

In the negative DBD-DCA (φ_{DC}<0, negative DC voltage applied to the third electrode), the thrust trends are similar to those of the positive DCA. The positive ions are accelerated towards the third electrode in the positive-going cycle. The thrust increases up to φ_{DC}=−16 kV, and sharply decreased when φ_{AC}=18 kV, whereas it continues to increase when φ_{AC}=14 kV case. The induced counter jet is formed later than in the positive DCA case. The mechanistic explanation for higher thrust achieved in the negative DCA is likely related to a greater abundance of positive species (i.e., higher discharge current).

For both DC polarities, the thrust increase in the complementary half-cycle exceeds the reduction in the other half cycle, increasing the overall thrust. In some embodiments, the AC cycle is composed of positive and negative corona-type discharges, where a positive discharge current is 2.5× higher than that of negative discharge current. The increase in the thrust is apparent in the negative DCA; however, it generates only 25% more thrust force than that of positive DCA. The likely explanation is that the negative semi-cycle generates a higher velocity than the positive one.

It should be noted that for purposes of this disclosure, terminology such as “upper,” “lower,” “vertical,” “horizontal,” “inwardly,” “outwardly,” “inner,” “outer,” “front,” “rear,” etc., should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings.

It should be understood that although the terms “first,” “second” and “third” can be used in the embodiments of the present disclosure to describe electrodes, these electrodes should not be limited to these terms. These terms are only used to distinguish the electrodes from each other. The term “about” means plus or minus 5% of the stated value.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

While illustrative embodiments have been illustrated and described, it will be appreciated that various changes can be made therein without departing from the spirit and scope of the invention.

What is claimed is:

1. A fluid flow actuator, comprising:
a dielectric sheet;
a first electrode of a dielectric barrier discharge-direct current augmented (DBD-DCA) actuator disposed on a first face of the dielectric sheet, wherein the first electrode is exposed to a surrounding fluid;
a second electrode of the DBD-DCA actuator disposed on a second face of the dielectric sheet, wherein the second face of the dielectric sheet is opposite from the first face of the dielectric sheet;
wherein the first electrode and the second electrode are configured for being coupled to an alternating current (AC) voltage source that is configured to locally ionize the surrounding fluid and to generate ions; and
a third electrode of the DBDA-DCA actuator disposed downstream from the first electrode and the second electrode, wherein the third electrode is configured for being coupled to a direct current (DC) voltage source configured to accelerate the ions.

2. The actuator of claim 1, wherein the third electrode is exposed to the surrounding fluid.

3. The actuator of claim 1, wherein the first electrode is saw-tooth shaped in a spanwise direction.

4. The actuator of claim 1, wherein the first electrode is finger-design shaped in a spanwise direction.

5. The actuator of claim 1, wherein the third electrode is energized to a negative DC voltage.

6. The actuator of claim 1, further comprising a source of the AC voltage coupled to the first electrode and the second electrode.

7. The actuator of claim 1, further comprising a source of the DC voltage coupled to the third electrode.

8. The actuator of claim 1, wherein the actuator is mounted on a surface of an aerodynamic structure.

9. The actuator of claim 1, wherein a thrust generated by the actuator corresponds to:
$$T = ( 1 - θ ) {F}_{EHD}$$
where F_{EHD} is a force induced by the ions corresponding to:
$${F}_{EHD} = {K}_{1} {{f}_{AC}^{α} ( {φ}_{AC} - {φ}_{o} )}^{2}$$
where K₁ and α are experimental constants corresponding to K₁=22.4×10⁻⁶ and α=0.8, φₒ is an initiation voltage, f_{AC} is a frequency of the AC voltage source, φ_{AC} is a voltage of the AC source, and θ is a non-dimensionless experimental quantity.

10. A method of accelerating fluid over an aerodynamic structure, the method comprising:
exposing a dielectric barrier discharge-direct current augmented (DBD-DCA) actuator to a flow of fluid, the DBD-DCA actuator having a first electrode disposed on a first face of a dielectric sheet and exposed to a surrounding fluid, and a second electrode disposed on a second face of the dielectric sheet opposite from the first face;
energizing the first electrode and the second electrode by an alternating current (AC) voltage;
locally ionizing the fluid to generate ions in the fluid; and
accelerating the ions using a third electrode of the DBD-DCA actuator that is coupled to a direct current (DC) voltage, wherein the third electrode is configured downstream of the first electrode and the second electrode, wherein the third electrode acts as an electrical sink that attracts the ions.

11. The method of claim 10, wherein the third electrode is energized to a negative DC voltage.

12. The method of claim 10, wherein the third electrode is energized to a positive DC voltage.

13. The method of claim 10, wherein the third electrode is exposed to the surrounding fluid.

14. The method of claim 10, wherein the third electrode is covered by an electrically insulating sheet.

15. The method of claim 10, wherein the first electrode is saw-tooth shaped in a spanwise direction.

16. The method of claim 15, wherein a distance between adjacent saw-teeth of the first electrode is about the same as a height of the saw-teeth.

17. The method of claim 10, wherein the first electrode is finger-design shaped in a spanwise direction.

18. The method of claim 17, wherein a distance between adjacent fingers of the first electrode is about twice smaller than a height of the fingers.

19. The method of claim 10, wherein the first electrode is a finger-design shaped in a spanwise direction.

20. The method of claim 10, wherein the actuator is configured on a surface of an aerodynamic structure in a co-flow orientation.

21. The method of claim 10, wherein the actuator is configured on a surface of an aerodynamic structure in a counter-flow orientation.

22. The method of claim 10, wherein the actuator is configured on a surface of an aerodynamic structure at an arbitrary angle to the free stream.

23. The method of claim 10, wherein the aerodynamic structure is configured on a lifting surface of an aircraft.

24. The method of claim 10, wherein the actuator is configured on a non-lifting surface of the aircraft.

25. The method of claim 10, wherein the actuator is configured on a suction side of an airfoil.

26. The method of claim 10, wherein the actuator is configured on a pressure side of an airfoil.
